(19) United States
(12) Patent Application Publication
(10) Pub. No.: US 2025/0260283 A1
(43) Pub. Date: Aug. 14, 2025

(54) ROTOR OF ROTARY ELECTRIC MACHINE

(71) Applicant: TOYOTA JIDOSHA KAUSHIKI KAISHA, Toyota-shi (JP)

(72) Inventors: Tatsuya NITTA, Toyota-shi (JP); Hiroki KATO, Toyota-shi (JP)

(73) Assignee: TOYOTA JIDOSHA KAUSHIKI KAISHA, Toyota-shi (JP)

(21) Appl. No.: 18/938,277

(22) Filed: Nov. 6, 2024

(30) Foreign Application Priority Data
Feb. 9, 2024 (JP) 2024-018909

(51) Int. Cl. H02K 1/32

(52) U.S. Cl. CPC H02K 1/32

(57) ABSTRACT

The rotor of the rotary electric machine includes: a plurality of refrigerant holes formed at intervals in the circumferential direction in the shaft so as to communicate with the shaft center hole; a plurality of refrigerant passages formed at intervals in the circumferential direction in the rotor core so as to extend in the axial direction on the radially outer side of the core center hole; a plurality of communication passages formed at intervals in the circumferential direction in the rotor core so as to communicate with the corresponding refrigerant passages at two different positions in the axial direction while communicating with the corresponding refrigerant holes; and a plurality of stress relaxation slots formed at intervals in the circumferential direction in the rotor core so as to surround the core center hole on the radially inner side of the refrigerant passages without interfering with the communication passages.

### CROSS-REFERENCE TO RELATED APPLICATION

This application claims priority to Japanese Patent Application No. 2024-018909 filed on Feb. 9, 2024, incorporated herein by reference in its entirety.

### BACKGROUND

### 1. Technical Field

The present disclosure relates to a rotor of a rotary electric machine, the rotor including a hollow shaft and an annular rotor core fixed to the shaft through interference fitting.

### 2. Description of Related Art

Conventionally, there has been known a rotor of a rotary electric machine, the rotor including a shaft having a refrigerant passage and a refrigerant supply port, a rotor core formed by stacking steel plates and fixed to the shaft, and a magnet accommodated in the rotor core (see Japanese Unexamined Patent Application Publication No. 2014-176235 (JP 2014-176235 A), for example). The magnet is accommodated in the rotor core so as to extend in the axial direction. The rotor core of the rotor has a first flow path that extends along the magnet in the vicinity of the magnet, and a second flow path that connects the refrigerant supply port of the shaft and the first flow path. The second flow path is formed symmetrically with respect to the radial direction of the rotor core by second slits provided in the steel plates constituting the central region in the axial direction of the rotor core. The first and second flow paths are merged in the central region in the axial direction of the rotor core to form a refrigerant flow path. With such a rotor of a rotary electric machine, it is possible to supply a cooling medium at a lower temperature to the periphery of the magnet where the temperature becomes high while suppressing a reduction in the strength of the steel plates due to the formation of the slits.

### SUMMARY

Here, in the rotor described above in which the rotor core including the first and second flow paths is fixed to the hollow shaft through interference fitting, it is necessary to suppress a decrease in the interference caused by the centrifugal force during high-speed rotation while relaxing the stress caused by the interference. However, JP 2014-176235 A mentioned above does not disclose or suggest a countermeasure for relaxing the stress caused by the interference or suppressing a decrease in the interference caused by the centrifugal force during high-speed rotation.

Thus, a main object of the present disclosure is to provide a rotor of a rotary electric machine, the rotor being capable of relaxing the stress caused by the interference and suppressing a decrease in the interference caused by the centrifugal force during high-speed rotation, while cooling a rotor core well.

An aspect of the present disclosure provides a rotor of a rotary electric machine. The rotor includes a hollow shaft and an annular rotor core fixed to the shaft through interference fitting. The rotor includes:
a plurality of refrigerant holes provided in the shaft at intervals in a circumferential direction so as to communicate with a shaft center hole of the shaft;
a plurality of refrigerant passages provided in the rotor core at intervals in the circumferential direction so as to extend in an axial direction on a radially outer side of a core center hole of the rotor core;
a plurality of communication passages provided in the rotor core at intervals in the circumferential direction so as to communicate with the corresponding refrigerant holes and communicate with the corresponding refrigerant passages at two different locations in the axial direction; and
a plurality of stress relaxation slots provided in the rotor core at intervals in the circumferential direction so as to surround the core center hole on a radially inner side of the refrigerant passages without interfering with the communication passages.

The rotor of a rotary electric machine according to the present disclosure includes a hollow shaft and an annular rotor core fixed to the shaft through interference fitting. The rotor core includes a plurality of refrigerant passages, a plurality of communication passages, and a plurality of stress relaxation slots. The refrigerant passages are provided in the rotor core at intervals in the circumferential direction so as to extend in the axial direction on the radially outer side of the core center hole of the rotor core. The communication passages are provided in the rotor core at intervals in the circumferential direction so as to communicate with the corresponding refrigerant holes formed in the shaft and communicate with the corresponding refrigerant passages at two different locations in the axial direction. Accordingly, the refrigerant supplied to the shaft center hole of the shaft can be supplied to the refrigerant passages via the refrigerant holes and the communication passages by the centrifugal force, cooling the rotor core well. Further, the stress relaxation slots are provided in the rotor core at intervals in the circumferential direction so as to surround the core center hole on the radially inner side of the refrigerant passages without interfering with the communication passages. Accordingly, it is possible to reduce the stress caused by the interference fitting between the shaft and the rotor core around the core center hole of the rotor core, and to reduce the centrifugal force acting on a portion of the rotating rotor core on the radially inner side of the stress relaxation slots. As a result, with the rotor of a rotary electric machine according to the present disclosure, it is possible to relax the stress caused by the interference and suppress a decrease in the interference caused by the centrifugal force during high-speed rotation, while cooling a rotor core well.

The refrigerant holes may be provided at intervals in the circumferential direction in a central region in the axial direction of the shaft; the communication passages may be provided at intervals in the circumferential direction in a central region in the axial direction of the rotor core;
the communication passages may include an inner communication portion that communicates with the refrigerant hole, a pair of outer communication portions provided at intervals in the axial direction so as to communicate with the refrigerant passage, and a pair of intermediate communication portions provided at intervals in the axial direction so as to communicate with the inner communication portion and a corresponding one of the outer communication portions; and
the stress relaxation slots may include a plurality of first slots provided on a radially outer side of the inner communication portion of the communication passages, a plurality of second slots provided between the intermediate communication portions of the communication passages in the circumferential direction, and a plurality of third slots provided on a radially inner side of the outer communication portion of the communication passages.

Accordingly, the communication passages and the stress relaxation slots can be provided in the rotor core without interfering with each other, and the refrigerant can be smoothly supplied to the refrigerant passages via the communication passages.

The rotor core may include a plurality of core plates stacked in the axial direction;
the core plates may include
a plurality of first core plates that includes an inner slit that defines the inner communication portion and a first slit that defines the first slot, a plurality of second core plates that includes an intermediate slit that defines the intermediate communication portion and a second slit that defines the second slot, a plurality of third core plates that includes an outer slit that defines the outer communication portion and a third slit that defines the third slot, and
fourth core plates that include a slit that defines the refrigerant passage and a fourth slit that defines the stress relaxation slot;
the second core plates may be stacked on both sides in the axial direction of the first core plates;
the third core plates may be stacked on the second core plates from both sides in the axial direction of the first core plates; and
the fourth core plates may be stacked on the third core plates from both sides in the axial direction of the first core plates.

Accordingly, it is possible to provide a plurality of refrigerant passages, a plurality of communication passages, and a plurality of stress relaxation slots in a rotor core while ensuring good assemblability of a rotor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing a rotor of a rotary electric machine of the present disclosure;

FIG. 2 is an enlarged cross-sectional view showing a rotor of the rotary electric machine of the present disclosure;

FIG. 3 is a plan view illustrating a first core plate forming a rotor core of a rotor of a rotary electric machine of the present disclosure;

FIG. 4 is a plan view illustrating a second core plate forming a rotor core of a rotor of a rotary electric machine of the present disclosure;

FIG. 5 is a plan view illustrating a third core plate forming a rotor core of a rotor of a rotary electric machine of the present disclosure; and

FIG. 6 is a plan view illustrating a fourth core plate forming a rotor core of a rotor of the rotary electric machine of the present disclosure.

### DETAILED DESCRIPTION OF EMBODIMENTS

Embodiments of the present disclosure will now be described with reference to the drawings.

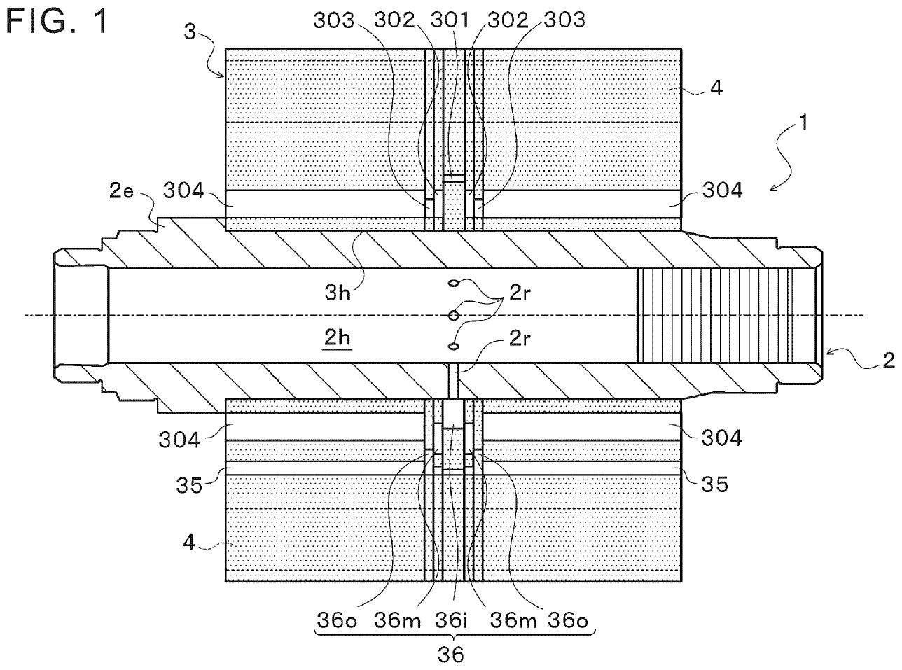

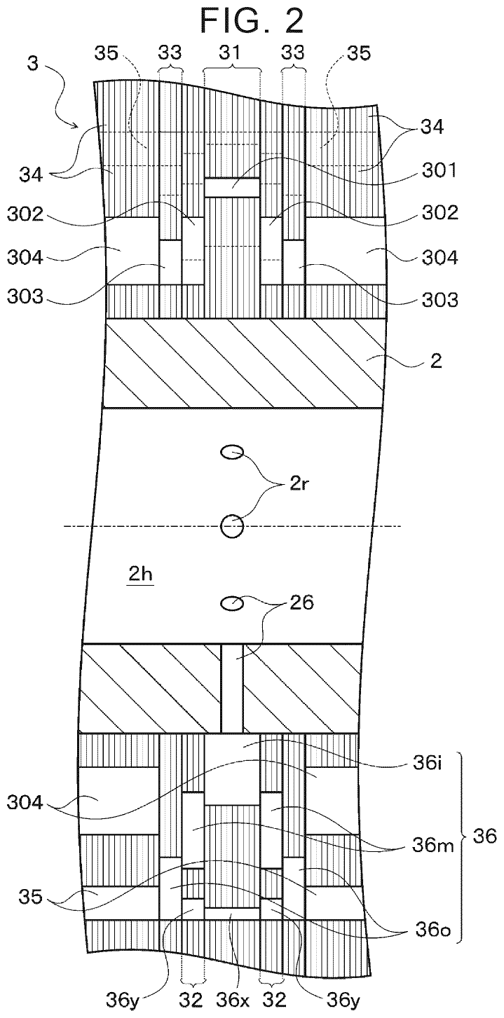

FIG. 1 is a schematic configuration diagram showing a rotor 1 of a rotary electric machine of the present disclosure, and FIG. 2 is an enlarged cross-sectional view of a main part showing the rotor 1. The rotor 1 shown in these drawings is a so-called embedded magnet-type (IPM type) rotor that constitutes a rotary electric machine (for example, a three-phase AC motor) together with a stator (not shown). As illustrated, the rotor 1 includes a rotor shaft 2, a rotor core 3 fixed to the rotor shaft 2 by interference fitting such as shrink fitting or press fitting, and a plurality of permanent magnets 4 embedded in the rotor core 3 so as to form a plurality of magnetic poles.

The rotor shaft 2 is hollow-formed of metal, and is interference-fitted to the core center hole 3h of the rotor core 3 so that the enlarged diameter portion 2e expanded radially outward from the outer peripheral surface abuts on one end surface of the rotor core 3. A coolant (for example, hydraulic fluid such as ATF) is supplied from a pump (not shown) to the shaft center hole 2h of the rotor shaft 2. In the central area in the longitudinal direction of the rotor shaft 2, a plurality of (for example, eight in the present embodiment) refrigerant 30 holes 2r are formed at intervals in the circumferential direction. The refrigerant holes 2r communicate with the shaft center hole 2h of the rotor shaft 2 and open at the outer peripheral surface of the rotor shaft 2.

As shown in FIG. 2, the rotor core 3 is formed by stacking a plurality of first core plates 31, a plurality of second core plates 32, a plurality of third core plates 33, and a plurality of fourth core plates 34 in the axial direction. The rotor core 3 further includes a plurality of refrigerant passages 35 and a plurality of communication passages 36. The refrigerant passages 35 are formed circumferentially spaced apart from the rotor core 3 so as to extend in the axial direction along the corresponding permanent magnets 4 radially outward of the core center hole 3h. Each of the refrigerant passages 35 extends from a central region in the axial direction of the rotor core 3 toward an end face of the corresponding rotor core 3, and opens at the corresponding end face. Further, the communication passages 36 are formed at intervals in the circumferential direction in the central region in the axial direction of the rotor core 3. The communication passages 36 include a single inner communication portion 36i, a pair of (two) outer communication portions 360, and a pair of (two) intermediate communication portions 36m, and extend stepwise from the core center hole 3h of the rotor core 3 toward the outer peripheral side as shown in FIGS. 1 and 2.

Each of the first, second, third, and fourth core plates 31, 32, 33, and 34 is formed in an annular shape from an electromagnetic steel sheet by, for example, press working. As shown in FIG. 2, in the present embodiment, a plurality of second core plates 32 are stacked on both sides in the axial direction of the first core plates 31. Further, a plurality of third core plates 33 are stacked on the second core plates 32 from both sides in the axial direction of the first core plates 31. Then, a plurality of fourth core plates 34 are stacked on the third core plates 33 from both sides in the axial direction of the first core plates 31.

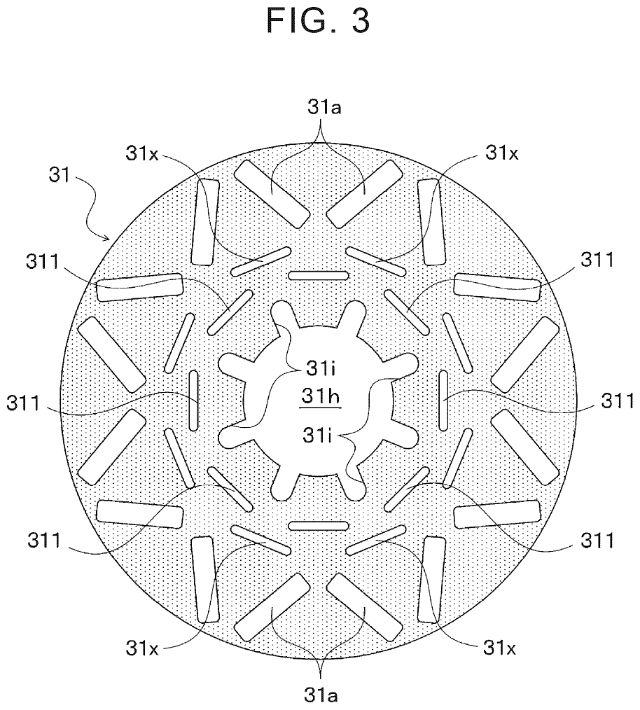

As shown in FIG. 3, the first core plate 31 includes a center hole 31h, a plurality of magnet slits 31a, a plurality of inner slits 31i, a plurality of slits 31x, and a plurality of first stress relaxation slits 311. The magnet slits 31a are arranged at predetermined intervals (45° intervals in the embodiment) by two. The two magnet slits 31a in a pair are formed so as to be spaced apart from each other from the center side toward the outer peripheral side of the first core plate 31 (so as to form a substantially V-shape). The inner slits 31i are circumferentially spaced (equally spaced) from the inner peripheral portion of the first core plate 31 so as to communicate (open) with the center hole 31h. The slits 31x are circumferentially spaced (equally spaced) so as to be located radially outward of the corresponding inner slits 31i. The first stress relaxation slits 311 are circumferentially spaced (equally spaced) between the inner slits 31i and the slits 31x in the radial direction so as to be located radially outward of the part between the inner slits 31i adjacent to each other in the circumferential direction.

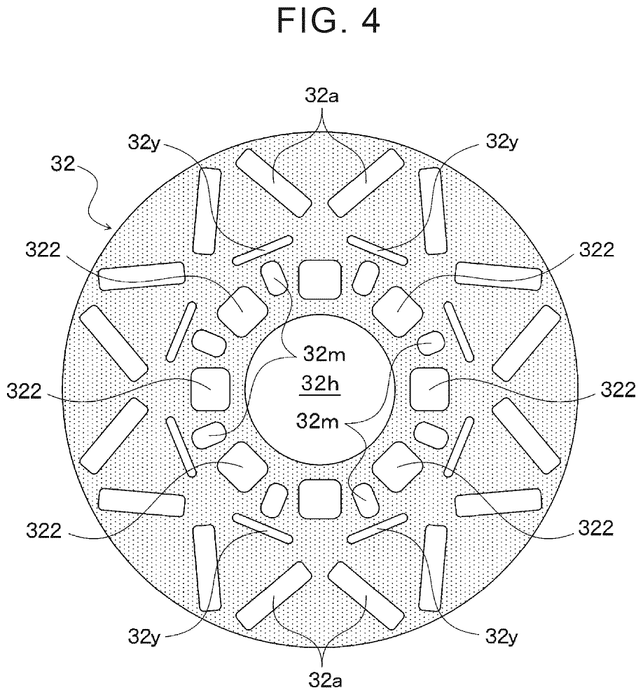

As shown in FIG. 4, the second core plate 32 includes a center hole 32h, a plurality of magnet slits 32a, a plurality of intermediate slits 32m, a plurality of slits 32y, and a plurality of second stress relaxation slits 322. The magnet slits 32a are arranged at predetermined intervals (45° intervals in the embodiment) by two. The two magnet slits 32a in a pair are formed so as to be spaced apart from each other from the center side toward the outer peripheral side of the second core plate 32 (so as to form a substantially V-shape). The intermediate slits 32m are arranged without communicating (opening) with the center hole 32h. Further, the intermediate slits 32m are arranged at intervals (at equal intervals) in the circumferential direction in the inner peripheral portion of the second core plate 32 so as to partially overlap with the corresponding inner slits 31i of the first core plate 31 when viewed from the axial direction. The slits 32y are circumferentially spaced (equally spaced) radially outward of the intermediate slits 32m. The second stress relaxation slits 322 are arranged at intervals (at equal intervals) in the circumferential direction on the radially inner side of the slits 32y so as to be positioned between the intermediate slits 32m adjacent to each other in the circumferential direction.

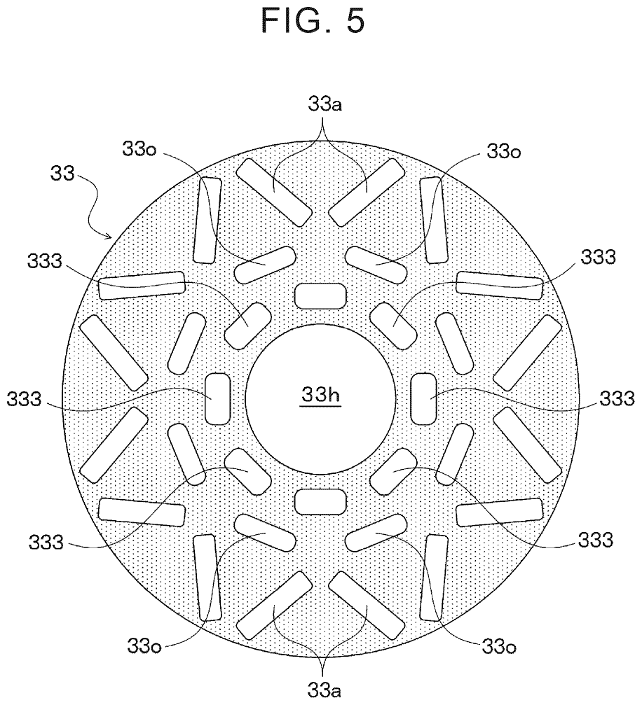

As shown in FIG. 5, the third core plate 33 includes a center hole 33h, a plurality of magnet slits 33a, a plurality of outer slits 330, and a plurality of third stress relaxation slits 333. The magnet slits 33a are arranged at predetermined intervals (45° intervals in the embodiment) by two. The two magnet slits 33a in a pair are formed so as to be spaced apart from each other from the center side toward the outer peripheral side of the third core plate 33 (so as to form a substantially V-shape). The outer slits 330 are circumferentially spaced (equally spaced) radially inward of the magnet slits 33a so as to partially overlap the corresponding intermediate slits 32m of the third core plate 33 when viewed from the axial direction. The third stress relaxation slits 333 are arranged radially inward of the part between the outer slit 330 adjacent to each other in the circumferential direction and circumferentially spaced (equally spaced) along the center hole 33h.

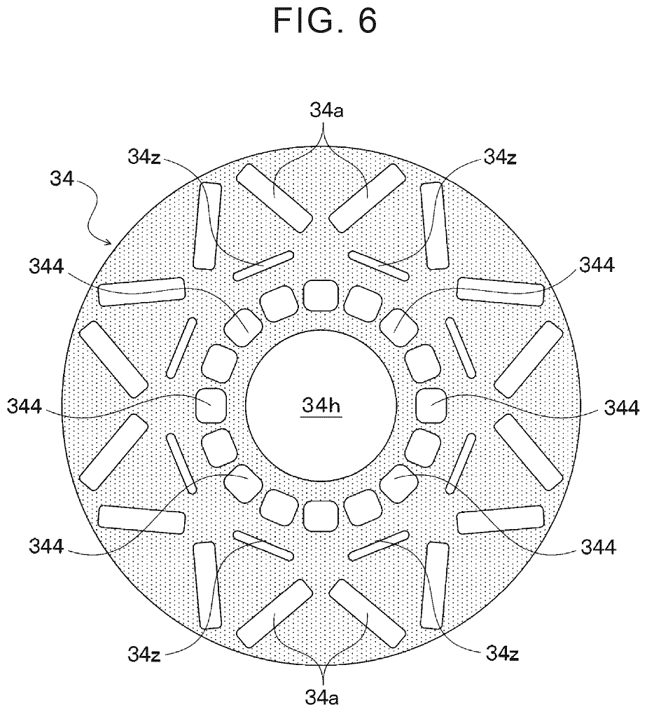

As shown in FIG. 6, the fourth core plate 34 includes a center hole 34h, a plurality of magnet slits 34a, a plurality of slit 34z, and a plurality of fourth stress relaxation slits 344. The magnet slits 34a are arranged at predetermined intervals (45° intervals in the embodiment) by two. The two magnet slits 34a in a pair are formed so as to be spaced apart from each other from the center side toward the outer peripheral side of the fourth core plate 34 (to form a substantially V-shape). The slit 34z are circumferentially spaced (equally spaced) radially inward of the magnet slits 34a so as to at least partially overlap the corresponding outer slit 330 of the third core plate 33 when viewed from the axial direction. The fourth stress relaxation slits 344 are circumferentially spaced (equally spaced) along the center hole 34h.

When a plurality of first, second, third and fourth core plates 31, 32, 33 and 34 are axially stacked, respectively, the center hole 31h, 32h, 33h, 34h defines the core center hole 3h of the rotor core 3. Further, when the first, second, third and fourth core plates 31, 32, 33, 34 are axially stacked, respectively, the magnet slits 31a, 32a, 33a, 34a overlapping each other defines a magnet holding portion for holding the permanent magnet 4.

In addition, when the first core plates 31 are axially stacked, the inner slits 31i overlapping each other define an inner communication portion 36i of the communication passage 36, and the slits 31x overlapping each other define a slot 36x (see FIG. 2) located radially outward of the inner communication portion 36i. Further, when the second core plates 32 are axially stacked, the overlapping intermediate slits 32m define an intermediate communication portion 36m of the communication passage 36, and the overlapping slits 32y define a slot 36y (see FIG. 2) located radially outward of the intermediate communication portion 36m. In addition, when the third core plates 33 are axially stacked, the outer slits 330 overlapping each other define an outer communication portion 360 of the communication passage 36, and when the fourth core plates 34 are axially stacked, the slit 34z overlapping each other define the refrigerant passage 35.

As shown in FIG. 2, the inner communication portions 36i of the respective communication passages 36 communicate with the corresponding refrigerant holes 2r. In addition, the pair of outer communication portions 360 of the respective communication passages 36 communicate with the corresponding refrigerant passages 35. Further, the pair of intermediate communication portions 36m of the respective communication passages 36 communicate with corresponding ones of the inner communication portion 36i and the pair of outer communication portions 360, respectively. As a result, the communication passages 36 communicate with the corresponding refrigerant holes 2r formed in the rotor shaft 2 and communicate with the corresponding refrigerant passages 35 at two different axial positions of the rotor shaft 2. Further, the pair of outer communication portions 360 communicate with each other via a slot 36x formed on the radially outer side of the inner communication portion 36i and a slot 36y formed on the radially outer side of the respective intermediate communication portions 36m.

Further, when the first core plates 31 are axially stacked, the overlapping first stress relaxation slits 311 define first stress relaxation slots 301. The first stress relaxation slot 301 is defined radially outward of the part between the circumferentially adjacent inner communication portions 36i and radially inward of the refrigerant passages 35. Further, when the second core plates 32 are axially stacked, the second stress relaxation slits 322 overlapping each other define the second stress relaxation slots 302 between the intermediate communication portions 36m adjacent to each other in the circumferential direction. Further, when the third core plates 33 are axially stacked, the third stress relaxation slits 333 overlapping each other define a third stress relaxation slot 303 radially inward of the part between the outer communication portions 360 adjacent to each other in the circumferential direction. Further, when the fourth core plates 34 are axially stacked, the fourth stress relaxation slits 344 overlapping each other define the fourth stress relaxation slots 304 so as to be aligned in the circumferential direction along the core center hole 3h. Thus, a plurality of first, second, third, and fourth stress relaxation slots 301-304 are formed in the rotor core 3 without interfering with the communication passages 36. Each of the first, second, third, and fourth stress relaxation slots 301-304 is circumferentially spaced to surround the core center hole 3h radially inward of the refrigerant passages 35.

As described above, the rotor 1 of the rotary electric machine includes the hollow rotor shaft 2 and the annular rotor core 3 fixed to the rotor shaft 2 by an interference fit. The rotor core 3 includes a plurality of refrigerant passages 35 and a plurality of communication passages 36. The refrigerant passages 35 are formed circumferentially spaced apart from each other in the rotor core 3 so as to extend in the axial direction radially outward of the core center hole 3h of the rotor core 3. Further, the communication passages 36 are formed circumferentially spaced apart from each other in the rotor core 3 so as to communicate with the corresponding refrigerant holes 2r formed in the rotor shaft 2 and communicate with the corresponding refrigerant passages 35 at two different positions in the axial direction.

As a result, when the rotor 1 is rotating, the coolant supplied to the shaft center hole 2h of the rotor shaft 2 flows from the refrigerant holes 2r to the inner communication portions 36i of the respective communication passages 36. The lubricating cooling medium flowing into the inner communication portions 36i flows into the corresponding refrigerant passages 35 and slotted 36x, 36y via the pair of intermediate communication portions 36m and the pair of outer communication portions 360. As a result, the respective permanent magnets 4 and thus the entire rotor core 3 can be satisfactorily cooled by the cooling medium flowing through the refrigerant passages 35 and the like. The cooling medium removes heat from the rotor core 3, flows out from the opening of each refrigerant passage 35 formed in the end face of the rotor core 3, and scatters radially outward by centrifugal force. The cooling medium scattered to the outside of the rotor core 3 is recovered in the case of the rotary electric machine, cooled by a cooler (not shown), and then supplied again to the rotor core 3 by the pump.

Further, the rotor core 3 includes a plurality of first, second, third, and fourth stress relaxation slots 301-304, respectively. The first, second, third, and fourth stress relaxation slots 301-304 are circumferentially spaced so as to surround the core center hole 3h radially inward of the refrigerant passages 35 without interfering with the communication passages 36. As a result, it is possible to reduce the stresses generated by the interference fit between the rotor shaft 2 and the rotor core 3 around the core center hole 3h of the rotor core 3. The centrifugal force acting on the radially inner portions of the first, second, third, and fourth stress relaxation slots 301-304 of the rotating rotor core 3 can then be reduced. As a result, in the rotor 1, it is possible to reduce the stress caused by the interference while cooling the rotor core 3 satisfactorily, and to suppress the decrease in the interference caused by the centrifugal force during high rotation.

Further, in the rotor 1, the refrigerant holes 2r are formed at intervals in the circumferential direction in the central region in the axial direction of the rotor shaft 2, and the communication passages 36 are formed at intervals in the circumferential direction in the central region in the axial direction of the rotor core 3. Further, the communication passages 36 each include an inner communication portion 36i communicating with the corresponding refrigerant hole 2r, a pair of outer communication portions 360 formed at intervals in the axial direction so as to communicate with the corresponding refrigerant passages 35, and a pair of intermediate communication portions 36m formed at intervals in the axial direction so as to communicate with the corresponding one of the inner communication portion 36i and the pair of outer communication portions 360, respectively. Further, the first stress relaxation slots 301 are formed on the radially outer side of the inner communication portion 36i of the communication passages 36, the second stress relaxation slots 302 are formed between the intermediate communication portions 36m of the communication passages 36 in the circumferential direction, and the third stress relaxation slots 303 are formed on the radially inner side of the outer communication portion 360 of the communication passages 36. As a result, the communication passages 36 and the first, second, and third stress relaxation slots 301-303 are formed in the rotor core 3 without interfering with each other, and the refrigerant can be smoothly supplied to each of the refrigerant passages 35 via the communication passages 36.

Further, the rotor core 3 is formed by laminating a plurality of first core plates 31, a plurality of second core plates 32, a plurality of third core plates 33, and a plurality of fourth core plates 34 in the axial direction. That is, the second core plates 32 are stacked on both sides in the axial direction of the first core plates 31, and the third core plates 33 are stacked on the second core plates 32 from both sides in the axial direction of the first core plates 31. Further, a plurality of fourth core plates 34 are stacked on the third core plates 33 from both sides in the axial direction of the first core plates 31. The first core plate 31 also includes an inner slit 31i defining an inner communication portion 36i and a first stress relaxation slit 311 defining a first stress relaxation slot 301. The second core plate 32 includes an intermediate slit 32m defining an intermediate communication portion 36m and a second stress relaxation slit 322 defining a second stress relaxation slot 302. Further, the third core plate 33 includes an outer slit 330 defining an outer communication portion 360 and a third stress relaxation slit 333 defining a third stress relaxation slot 303. The fourth core plate 34 includes a slit 34z defining a refrigerant passage 35 and a fourth stress relaxation slit 344 defining a fourth stress relaxation slot 304. This makes it possible to form the refrigerant passages 35, the communication passages 36, and the first, second, third, and fourth stress relaxation slots 301-304 in the rotor core 3, respectively, while ensuring good assemblability of the rotor 1.

The cross-sectional shapes of the inner slit 31i and the first stress relaxation slit 311 of the first core plate 31, the intermediate slit 32m and the second stress relaxation slit 322 of the second core plate 32, the outer slit 330 and the third stress relaxation slit 333 of the third core plate 33, and the slit 34z and the fourth stress relaxation slit 344 of the fourth core plate 34 are not limited to those illustrated in FIGS. 3 to 6. It goes without saying that any cross-sectional shape can be adopted for these slits depending on the specifications of the rotor core 3 and the like.

In addition, the disclosure of the present disclosure is not limited to the above-described embodiments, and it is needless to say that various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The disclosure of the present disclosure can be used in a manufacturing industry of a rotary electric machine and the like.

What is claimed is:

1. A rotor of a rotary electric machine, the rotor including a hollow shaft and an annular rotor core fixed to the shaft through interference fitting, and the rotor comprising:
a plurality of refrigerant holes provided in the shaft at intervals in a circumferential direction so as to communicate with a shaft center hole of the shaft;
a plurality of refrigerant passages provided in the rotor core at intervals in the circumferential direction so as to extend in an axial direction on a radially outer side of a core center hole of the rotor core;
a plurality of communication passages provided in the rotor core at intervals in the circumferential direction so as to communicate with the corresponding refrigerant holes and communicate with the corresponding refrigerant passages at two different locations in the axial direction; and
a plurality of stress relaxation slots provided in the rotor core at intervals in the circumferential direction so as to surround the core center hole on a radially inner side of the refrigerant passages without interfering with the communication passages.

2. The rotor of a rotary electric machine according to claim 1, wherein:
the refrigerant holes are provided at intervals in the circumferential direction in a central region in the axial direction of the shaft;
the communication passages are provided at intervals in the circumferential direction in a central region in the axial direction of the rotor core;
the communication passages include an inner communication portion that communicates with the refrigerant hole, a pair of outer communication portions provided at intervals in the axial direction so as to communicate with the refrigerant passage, and a pair of intermediate communication portions provided at intervals in the axial direction so as to communicate with the inner communication portion and a corresponding one of the outer communication portions; and
the stress relaxation slots include a plurality of first slots provided on a radially outer side of the inner communication portion of the communication passages, a plurality of second slots provided between the intermediate communication portions of the communication passages in the circumferential direction, a plurality of third slots provided on a radially inner side of the outer communication portion of the communication passages, and a plurality of fourth slots provided so as to be aligned in the circumferential direction along the core center hole in a region other than the central region of the rotor core.

3. The rotor of a rotary electric machine according to claim 2, wherein:
the rotor core includes a plurality of core plates stacked in the axial direction;
the core plates include
a plurality of first core plates that includes an inner slit that defines the inner communication portion and a first slit that defines the first slot,
a plurality of second core plates that includes an intermediate slit that defines the intermediate communication portion and a second slit that defines the second slot,
a plurality of third core plates that includes an outer slit that defines the outer communication portion and a third slit that defines the third slot, and
fourth core plates that include a slit that defines the refrigerant passage and a fourth slit that defines the fourth slot;
the second core plates are stacked on both sides in the axial direction of the first core plates;
the third core plates are stacked on the second core plates from both sides in the axial direction of the first core plates; and
the fourth core plates are stacked on the third core plates from both sides in the axial direction of the first core plates.
